(19) United States
(12) Patent Application Publication
(10) Pub. No.: US 2024/0383500 A1
(43) Pub. Date: Nov. 21, 2024

(54) CONSENSUS DETERMINATION SYSTEM FOR AUTONOMOUS VEHICLE SHARED RIDE CONDITIONS

(71) Applicant: GM Cruise Holdings LLC, San Francisco, CA (US)

(72) Inventors: Jennifer Devar McKnew, Petaluma, CA (US); Alexander Willem Gerrese, San Francisco, CA (US); Spencer Lee James, Santa Clara, CA (US); Yifei Zhang, San Francisco, CA (US)

(73) Assignee: GM Cruise Holdings LLC, San Francisco, CA (US)

(21) Appl. No.: 18/318,918

(22) Filed: May 17, 2023

(51) Int. Cl. B60W 60/00; B60W 40/08; B60W 50/08

(52) U.S. Cl. CPC B60W 60/0013; B60W 40/08; B60W 50/087; A63F 13/798; B60W 2540/043; B60W 2540/047; B60W 2540/221

(57) ABSTRACT

A method of managing a condition of a shared ride provided using an autonomous vehicle (AV) is described and includes determining individual preferences for the condition expressed by passengers participating in the shared ride; determining a consensus preference for the condition based on the individual preferences; and applying the consensus preference for the condition for at least a portion of the shared ride, wherein the applying the consensus preference for the condition comprises managing settings of the AV, including settings of a cabin of the AV.

### BACKGROUND

### Technical Field

The present disclosure relates generally to autonomous vehicles (AVs) and, more specifically, to techniques for implementing a consensus determination system for shared ride conditions for such AVs.

### Introduction

An AV is a motorized vehicle that can navigate without a human driver. An exemplary AV can include various sensors, such as a camera sensor, a light detection and ranging (LIDAR) sensor, and a radio detection and ranging (RADAR) sensor, among others. The sensors collect data and measurements that the AV can use for operations such as navigation. The sensors can provide the data and measurements to an internal computing system of the AV, which can use the data and measurements to control a mechanical system of the AV, such as a vehicle propulsion system, a braking system, or a steering system. Typically, the sensors are mounted at fixed locations on the AVs.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate AV (AV) dispatch and operations, according to some aspects of the disclosed technology;

FIGS. 2A-2I collectively illustrate a simplified example of a shared ride provided by an AV according to some aspects of the disclosed technology;

FIGS. 3A-3C illustrate various techniques for implementing a consensus system for AV shared ride according to some aspects of the disclosed technology;

FIG. 4 illustrates a flow diagram of example operations for enabling a method for consensus determination for AV shared rides, according to some aspects of the disclosed technology; and

FIG. 5 illustrates an example processor-based system with which some aspects of the disclosed technology can be implemented.

### DETAILED DESCRIPTION

### Overview

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Given the numerous advantages of ride hail, rideshare, and delivery services provided by AVs, it is anticipated that AV provision of such services will soon become the ubiquitous choice for various user transportation and delivery needs, including but not limited to school commutes, airport transfers, long distance road trips, and grocery and restaurant deliveries, to name a few.

In some particular instances of rideshare services, which may be alternatively referred to herein as shared ride or pooled ride services, multiple unacquainted passengers may share the same AV for period of time. When a passenger books a shared ride, often exchange for a reduced service rate, the passenger may be grouped with other passengers headed in generally the same direction as each other during generally the same time frame. Depending on the time of day, season, total number of passengers, and other factors, the shared AV may make stops along the way to pick up and/or drop off passengers.

It will be recognized that the combination of unacquainted passengers in a shared AV may result in certain challenges when, as will often be the case, one of the passengers has a preference that conflicts with the preference of another one of the passengers. Such differences may arise in the context of environmental preferences (e.g., AV cabin temperature, noise level, level and type of lighting, etc.), social preferences (e.g., level of desired interaction between passengers, type of music or other media presentations, etc.), health considerations (e.g., allergies and the like), and physical preferences (e.g., seat location, in-cabin amenities), to name a few.

In accordance with features of embodiments described herein, techniques are provided for implementing a consensus system for shared ride conditions for AVs. In certain embodiments, one or more techniques may be automatically deployed to determine consensus settings for a shared ride provided by an AV. As will be described in detail below, such techniques may include one or more of voting, pre-matching, averaging (which can be weighted or unweighted), gaming, and pre-selection. In accordance with features of some embodiments, the consensus settings may be updated throughout the shared ride as passengers are picked up and dropped off.

The following detailed description presents various descriptions of specific certain embodiments. However, the innovations described herein can be embodied in a multitude of different ways, for example, as defined and covered by the claims and/or select examples. In the following description, reference is made to the drawings, in which like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the drawings, a particular number and arrangement of structures and components are presented for illustrative purposes and any desired number or arrangement of such structures and components may be present in various embodiments. Further, the structures shown in the figures may take any suitable form or shape according to material properties, fabrication processes, and operating conditions. For convenience, if a collection of drawings designated with different letters are present (e.g., FIGS. 10A-10C), such a collection may be referred to herein without the letters (e.g., as “FIG. 10”). Similarly, if a collection of reference numerals designated with different letters are present (e.g., 110a-110e), such a collection may be referred to herein without the letters (e.g., as “110”).

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y. The terms “substantially,” “close,” “approximately,” “near,” and “about,” generally refer to being within +/−20% of a target value (e.g., within +/−5 or 10% of a target value) based on the context of a particular value as described herein or as known in the art.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

### Example AV Management System

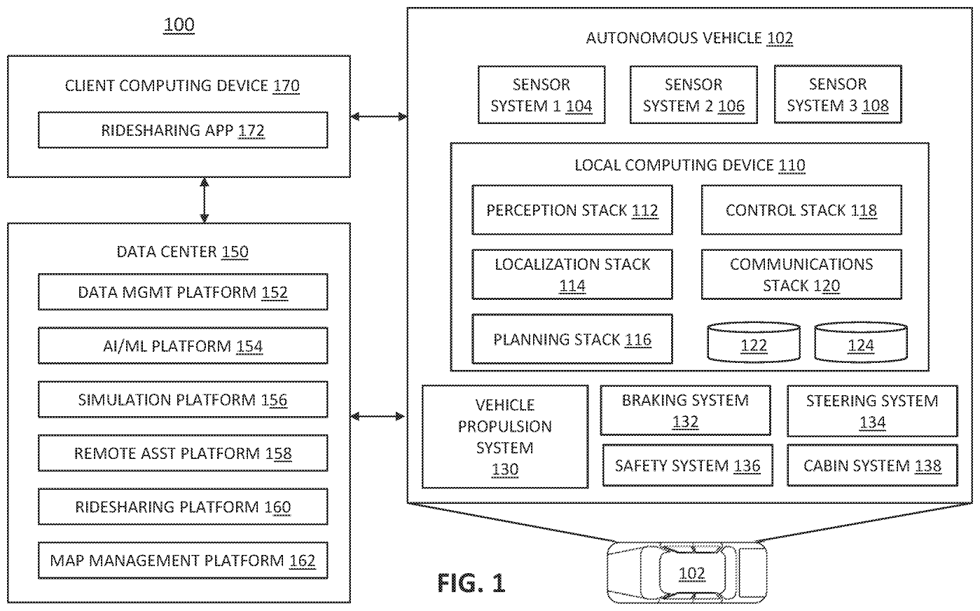

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (Saas) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate about roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

AV 102 can also include several mechanical systems that can be used to maneuver or operate AV 102. For instance, the mechanical systems can include vehicle propulsion system 130, braking system 132, steering system 134, safety system 136, and cabin system 138, among other systems. Vehicle propulsion system 130 can include an electric motor, an internal combustion engine, or both. The braking system 132 can include an engine brake, a wheel braking system (e.g., a disc braking system that utilizes brake pads), hydraulics, actuators, and/or any other suitable componentry configured to assist in decelerating AV 102. The steering system 134 can include suitable componentry configured to control the direction of movement of the AV 102 during navigation. Safety system 136 can include lights and signal indicators, a parking brake, airbags, and so forth. The cabin system 138 can include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a planning stack 116, a control stack 118, a communications stack 120, a High Definition (HD) geospatial database 122, and an AV operational database 124, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). The perception stack 112 can detect and classify objects and determine their current and predicted locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth.

Mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 122 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The planning stack 116 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 102 from one point to another. The planning stack 116 can determine multiple sets of one or more mechanical operations that the AV 102 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 can select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 can manage the operation of the vehicle propulsion system 130, the braking system 132, the steering system 134, the safety system 136, and the cabin system 138. The control stack 118 can receive sensor signals from the sensor systems 104-108 as well as communicate with other stacks or components of the local computing device 110 or a remote system (e.g., the data center 150) to effectuate operation of the AV 102. For example, the control stack 118 can implement the final path or actions from the multiple paths or actions provided by the planning stack 116. This can involve turning the routes and decisions from the planning stack 116 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 122 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

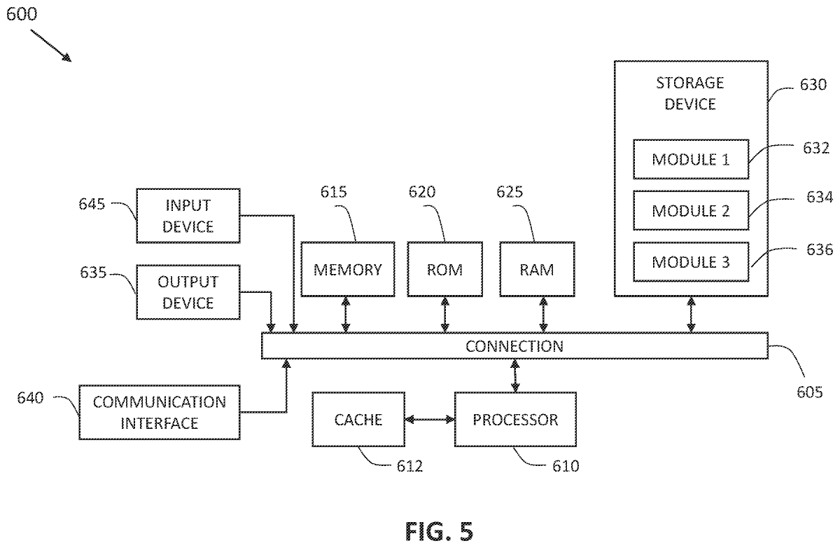

The AV operational database 124 can store raw AV data generated by the sensor systems 104-108 and other components of the AV 102 and/or data received by the AV 102 from remote systems (e.g., the data center 150, the client computing device 170, etc.). In some embodiments, the raw AV data can include HD LIDAR point cloud data, image or video data, RADAR data, GPS data, and other sensor data that the data center 150 can use for creating or updating AV geospatial data as discussed further below with respect to FIG. 5 and elsewhere in the present disclosure.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes one or more of a data management platform 152, an Artificial Intelligence/Machine Learning (AI/ML) platform 154, a simulation platform 156, a remote assistance platform 158, a ridesharing platform 160, and a map management platform 162, among other systems.

Data management platform 152 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to be picked up or dropped off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

### Example Shared Ride Provided by an AV

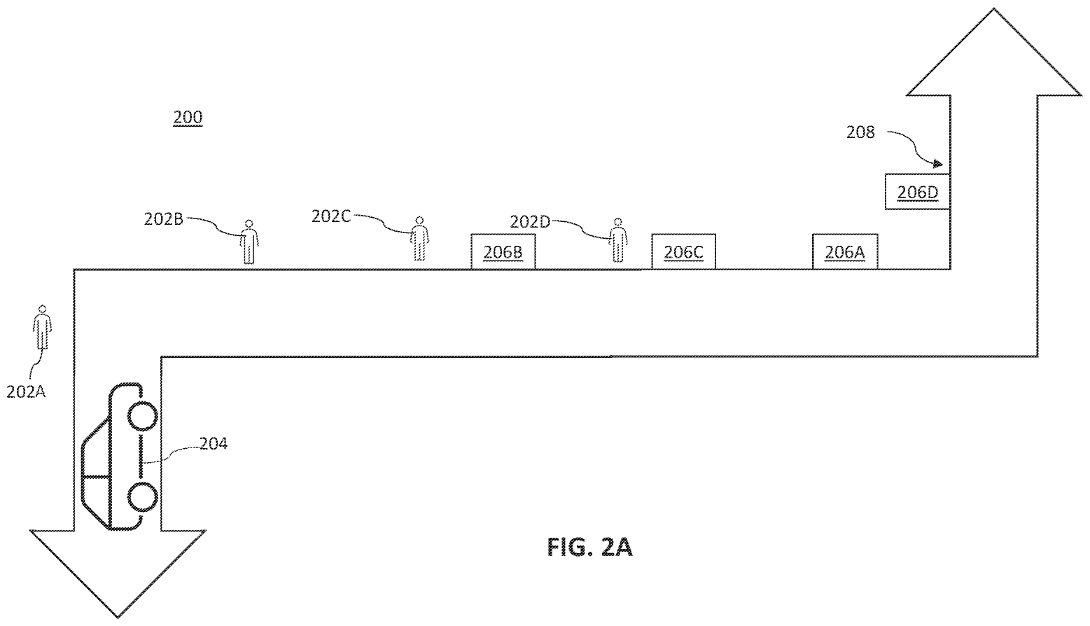

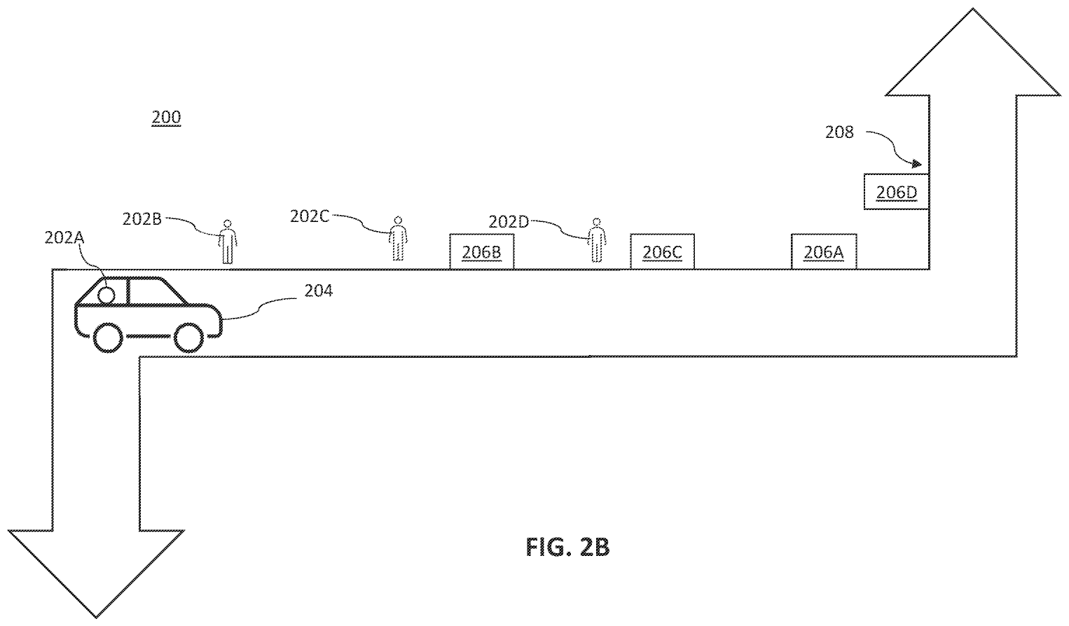

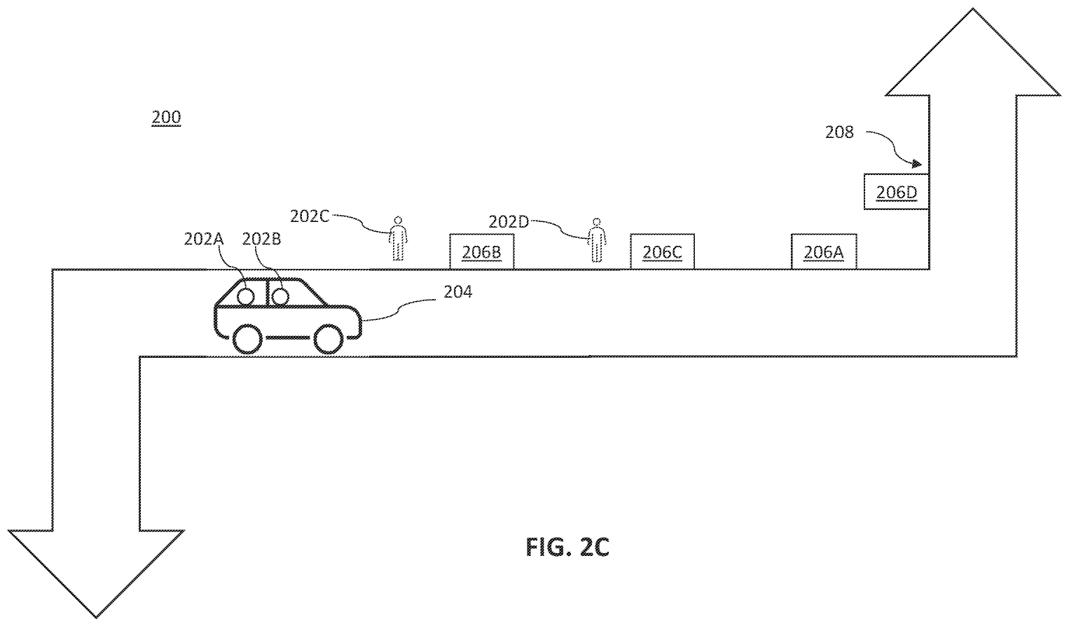

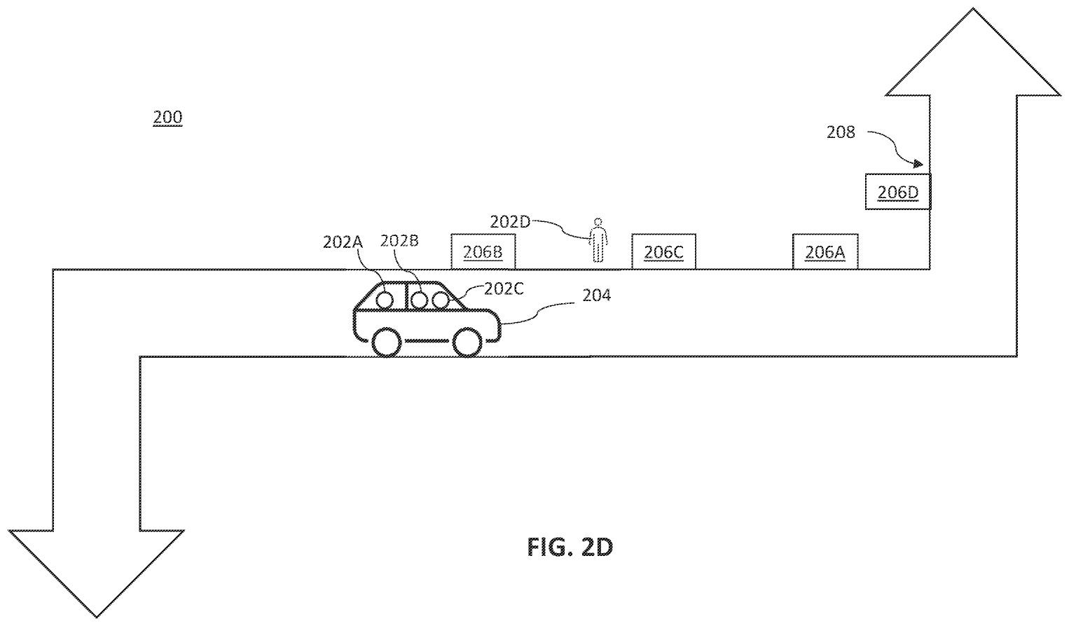

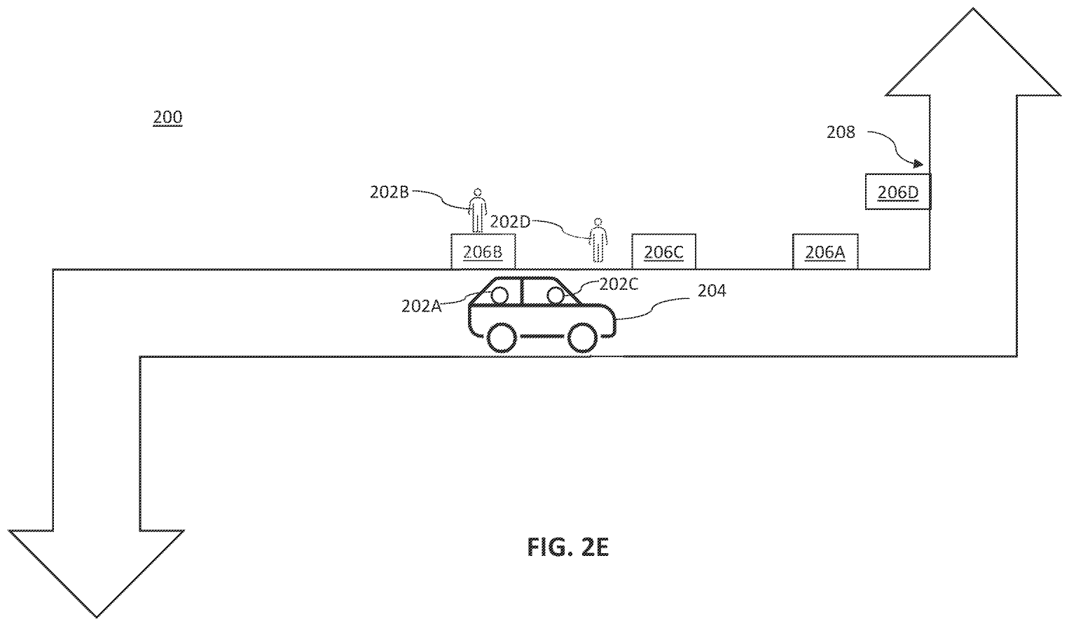

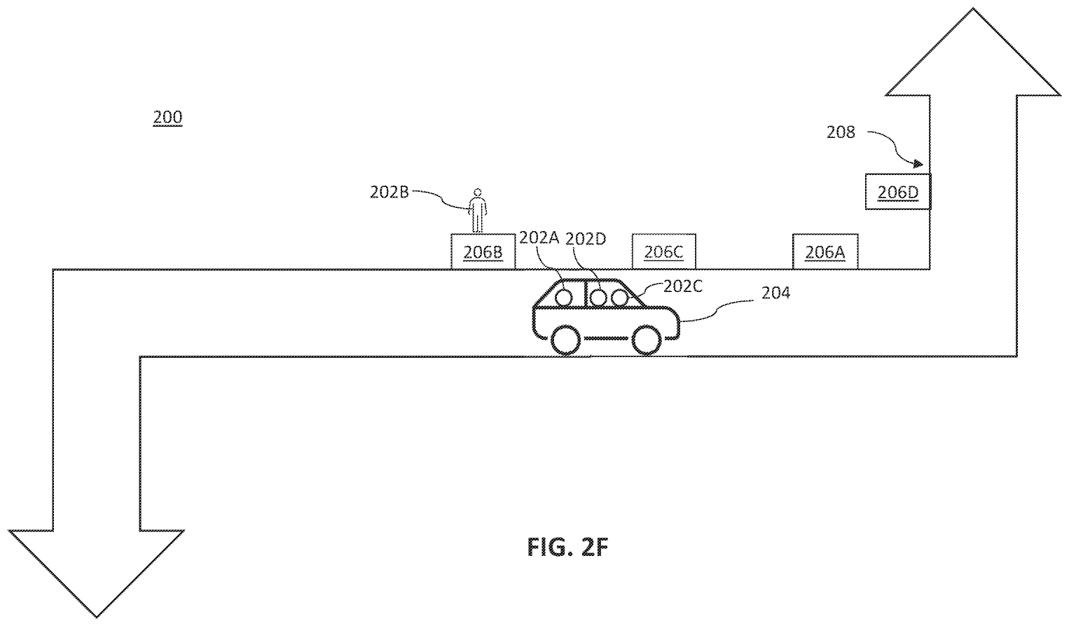

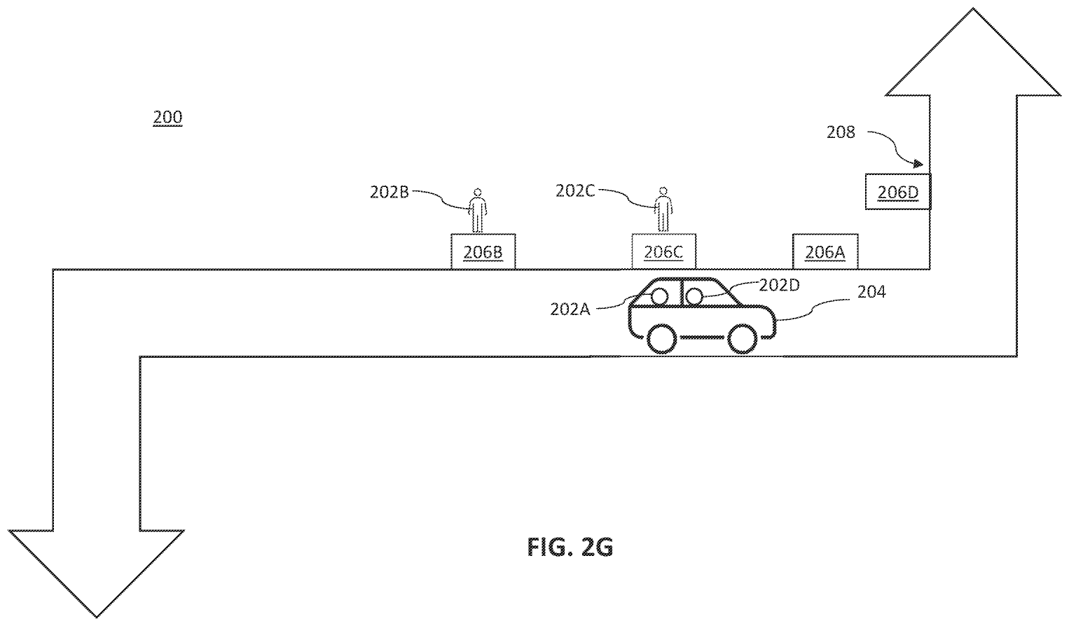

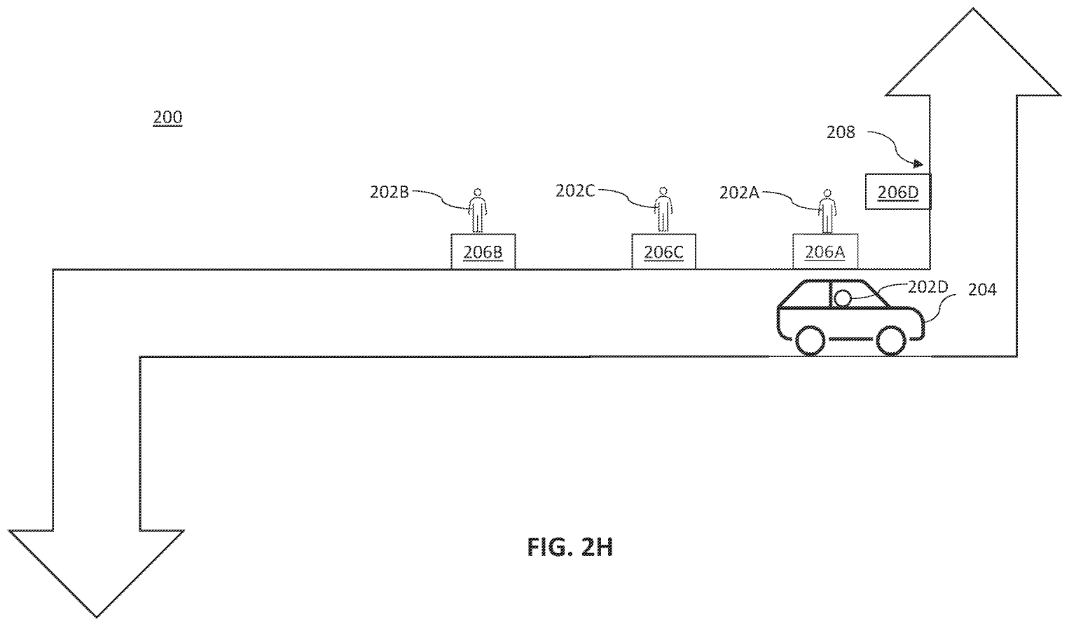

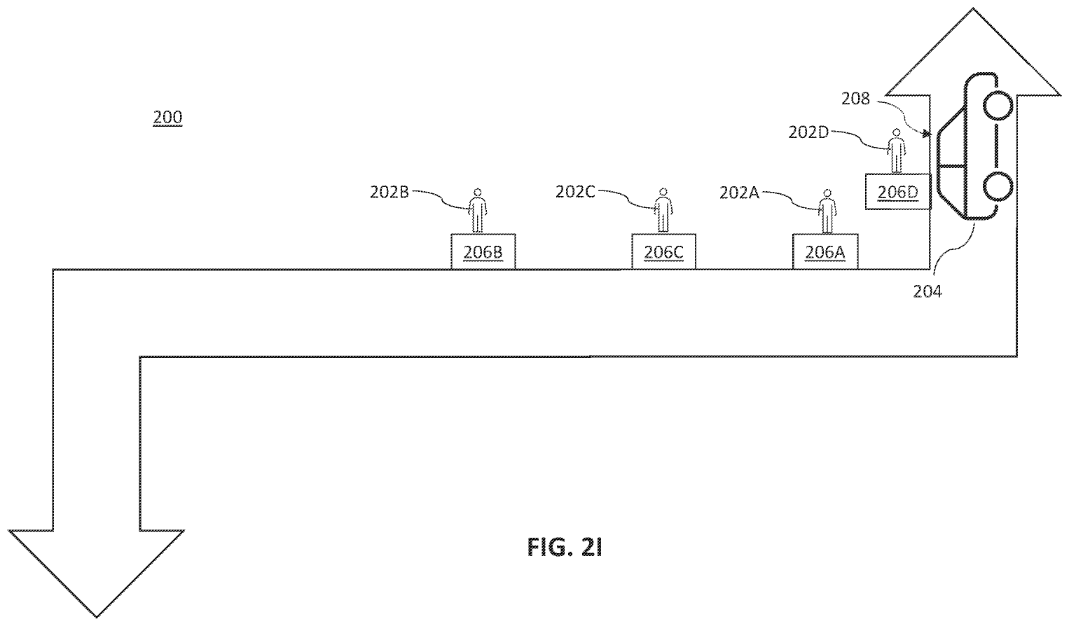

FIGS. 2A-2I illustrate a simplified example 200 of a shared ride in which passengers 202A-202D are transported by a shared AV 204 to corresponding destinations 206A-206D along a route 208. As shown in FIG. 2B, passenger 202A, destined for destination 206A, is the first passenger picked up by the AV 204. Referring now to FIG. 2C, on the way to destination 206A, a second passenger (passenger 202B), destined for destination 206B, is picked up by the AV 204. At this point, there are two passengers (passengers 202A and 202B) in the cabin of the AV 204.

Continuing to FIG. 2D, on the way to destination 206B (which is closer to the current location of the AV 204 along the route 208 than the destination 206A), a third passenger (passenger 202C), destined for destination 206C, is picked up by the AV 204. At this point, there are three passengers (passengers 202A, 202B, and 202C) in the cabin of the AV 204. Referring next to FIG. 2E, once passenger 202B is dropped off at destination 206B, there are once again two passengers (passengers 202A and 202C) in the cabin of the AV 204. Prior to dropping off passenger 202A at destination 206A, a fourth passenger (passenger 202D), destined for destination 206D, is picked up by the AV 204, at which point there are again three passengers (passengers 202A, 202C, and 202D) in the AV, as shown in FIG. 2F. As shown in FIG. 2G, once destination 206C is reached, passenger 202C is dropped off and only two passengers (passengers 202A and 202D) remain in the cabin of the AV 204.

The AV 204 proceeds along the route 208, dropping off passenger 202A at destination 206A (FIG. 2H) before finally dropping off passenger 202D, who at that point is the sole passenger in the AV, at destination 206D (FIG. 2I). In the example 200 shown in FIGS. 2A-2I, as further illustrated in TABLE I below, passenger 202A is the sole passenger in the AV 204 for a first period of time (T1), passengers 202A and 202B share the AV 204 for a second period of time (T2), passengers 202A, 202B, and 202C share the AV 204 for a third period of time (T3), passengers 202A and 202C share the AV 204 for a fourth period of time (T4), passengers 202A, 202C, and 202D share the AV 204 for a fifth period of time (T5), passengers 202A and 202D share the AV 204 for a sixth period of time (T6), and passenger 202D is the sole passenger of the AV 204 for the seventh and final period of time (T7).

TABLE I

| TIME PERIOD | PASSENGERS |
|---|---|
| T1 | 202A |
| T2 | 202A, 202B |
| T3 | 202A, 202B, 202C |
| T4 | 202A, 202C |
| T5 | 202A, 202C, 202D |
| T6 | 202A, 202D |
| T7 | 202D |

### Example Techniques for Consensus Determination for AV Shared Rides

As previously noted, there are a variety of factors that may impact the convenience and/or comfort of a vehicle passenger. When the passenger is the only passenger in the vehicle, most, if not all, of the passenger's individual preferences (which may be indicated in a user profile of the passenger) may be accommodated; however, in a shared ride situation in which two or more unacquainted passengers share an AV for a period of time, differences in the passengers' individual preferences may negatively impact the convenience and/or comfort of one or more of the others.

For example, one passenger may prefer the AV cabin be maintained at or around a first temperature, whereas a second passenger may prefer the AV cabin be maintained at a second temperature significantly lower than the first temperature and a third passenger may prefer that the AV cabin temperature be maintained at a temperature significantly higher than the first temperature. In another example, a first passenger may prefer the cabin to be dimly lit while a second passenger may prefer the cabin to be brightly lit. In yet another example, a first passenger may prefer classical music at a low volume while a second passenger may prefer heavy metal music at a high volume.

In accordance with features of embodiments described herein, techniques are provided for implementing a consensus system for AV shared rides. In particular, one or more techniques may be automatically deployed to determine consensus settings for a shared ride provided by an AV.

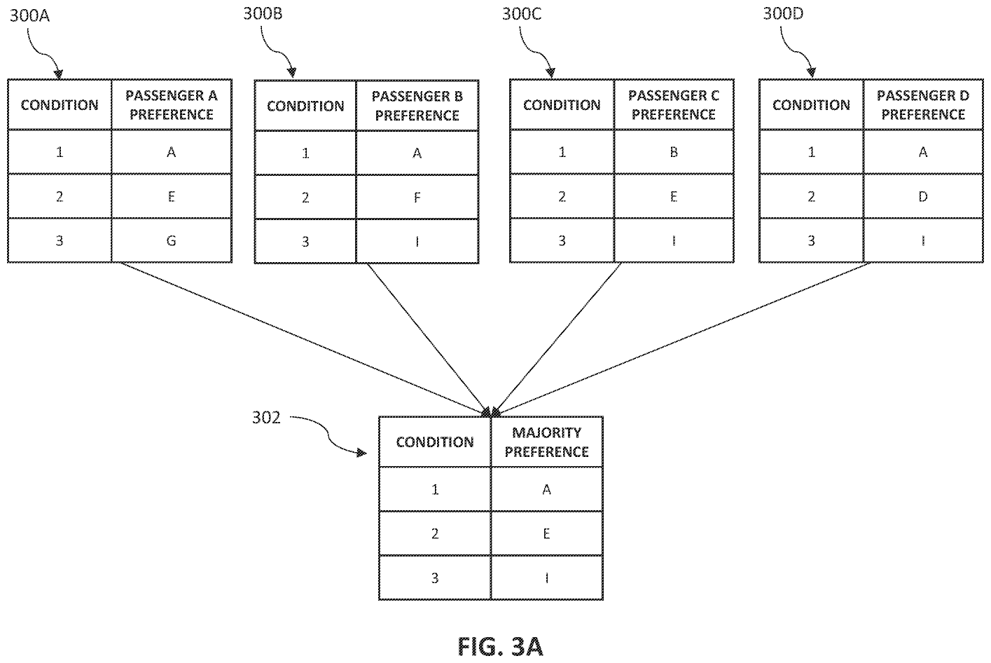

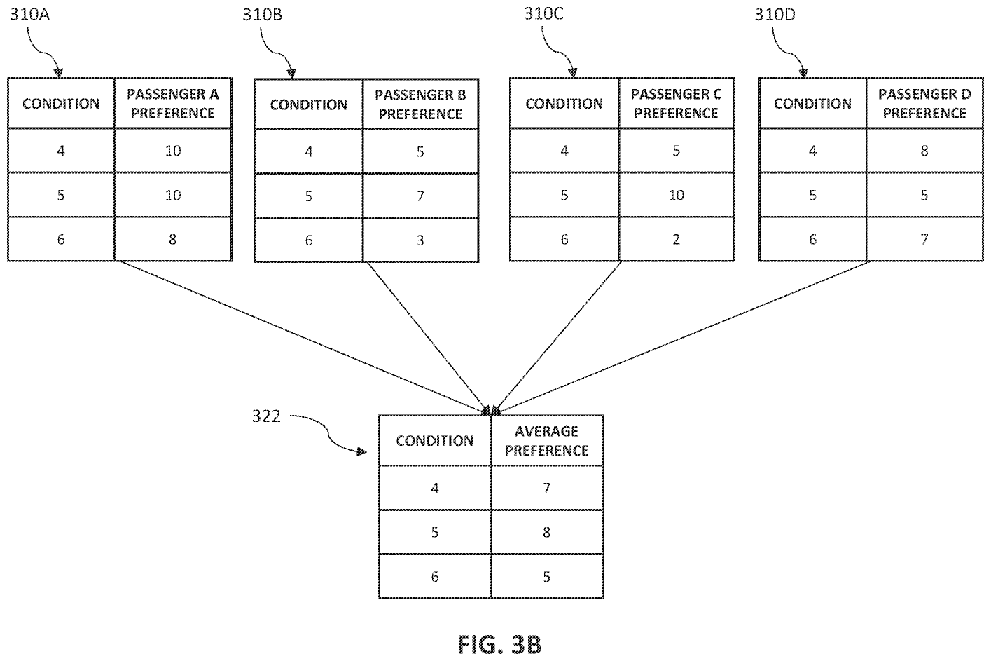

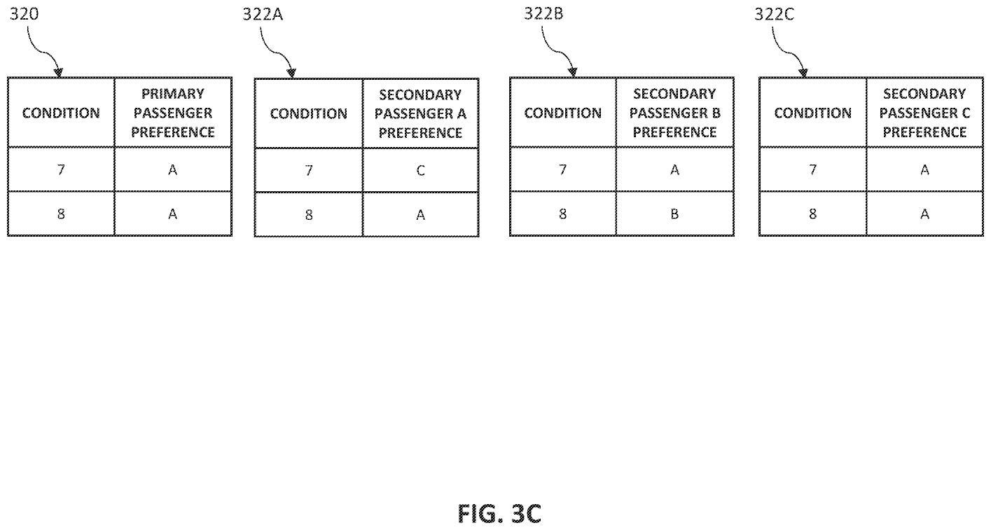

One technique may be referred to herein as majority voting and is illustrated in FIG. 3A. As illustrated in FIG. 3A, preferences of four passengers (e.g., passengers A-D) with respect to three conditions (conditions 1-3) are respectively represented in tables 300A-300D. It will be recognized that the preferences shown in the tables 300A-300D may be indicated or otherwise selected by the passengers in their corresponding user profiles. For example, table 300A, corresponding to passenger A, indicates that passenger A has expressed a preference A in connection with condition 1, a preference E in connection with condition 2, and a preference G in connection with condition 3. Similarly, table 300B, corresponding to passenger B, indicates that passenger B has expressed a preference A in connection with condition 1, a preference F in connection with condition 2, and a preference I in connection with condition 3. Table 300C, corresponding to passenger C, indicates that passenger C has expressed a preference B in connection with condition 1, a preference E in connection with condition 2, and a preference I in connection with condition 3. Finally, table 300D, corresponding to passenger D, indicates that passenger D has expressed a preference A in connection with condition 1, a preference D in connection with condition 2, and a preference I in connection with condition 3.

Applying the voting technique, the majority preference for each condition is applied as the preference for the shared ride while the passengers remain in the AV. In the illustrated example, referring to table 302, the majority preference for condition 1 is A, the majority preference for condition 2 is E, and the majority preference for condition 3 is I. As a result, using the voting technique, so long as passengers A, B, C, and D remain in the vehicle, the preferences represented in table 302 will be applied.

The voting technique illustrated in FIG. 3A may be particularly useful in connection with conditions for which there are a limited number of discrete choices (e.g., on/off or high/medium/low).

In direct contrast to the majority voting technique, a least common denominator (LCD) technique may be employed for certain conditions. For example, in the context of noise level of an AV, priority may be given to the preference of the passenger who would like the lowest level of noise in the car, such that if a “quiet” passenger joins a “social” shared ride, the shared ride immediately converts to a “quiet” ride. Similarly, if a passenger who is allergic to cats is participating in a shared ride, no passenger traveling with a cat will be permitted to join the ride.

Another technique may be referred to herein as averaging and is illustrated in FIG. 3B. As illustrated in FIG. 3B, preferences of four passengers (e.g., passengers A-D) with respect to three conditions (conditions 4-6) are respectively represented in tables 310A-310D. It will be recognized that the preferences shown in the tables 310A-310D may be indicated or otherwise selected by the passengers in their corresponding user profiles. For example, table 310A, corresponding to passenger A, indicates that passenger A has expressed a preference 10 in connection with condition 4, a preference 10 in connection with condition 5, and a preference 8 in connection with condition 6. Similarly, table 310B, corresponding to passenger B, indicates that passenger B has expressed a preference 5 in connection with condition 4, a preference 7 in connection with condition 5, and a preference 3 in connection with condition 6. Table 310C, corresponding to passenger C, indicates that passenger C has expressed a preference 5 in connection with condition 4, a preference 10 in connection with condition 5, and a preference 2 in connection with condition 6. Finally, table 310D, corresponding to passenger D, indicates that passenger D has expressed a preference 8 in connection with condition 4, a preference 5 in connection with condition 5, and a preference 7 in connection with condition 6.

Applying the averaging technique, the average passenger preference for each condition is applied as the preference for the shared ride while the passengers remain in the AV. In the illustrated example, referring to table 312, the average preference for condition 4 is 7, the average preference for condition 5 is 8, and the average preference for condition 6 is 5. As a result, using the averaging technique, so long as passengers A, B, C, and D remain in the vehicle, the preferences represented in table 312 will be applied.

It will be recognized that a weighted averaging technique may be applied with respect to some or all conditions of interest, with the preferences of particular passengers in general or with respect to particular conditions being more heavily weighted than those of other passengers in general or with respect to the particular conditions. For example, preferences of users who have indicated they are susceptible to motion sickness or who have certain accessibility toggles enabled may be weighted more heavily, while preferences of users who have a relatively short trip or a poor rating may be weighted less heavily. The averaging technique illustrated in FIG. 3B may be particularly useful in connection with conditions that can be characterized by a numerical value within a recognized range of values (e.g., temperature or cabin illumination).

Yet another technique may be referred to herein as pre-matching and is illustrated in FIG. 3C. As illustrated in FIG. 3C, preferences of four passengers (e.g., primary passenger and secondary passengers A-C) with respect to two conditions (conditions 7 and 8) are respectively represented in tables 320 and 322A-322C. It will be recognized that the preferences shown in the tables may be indicated or otherwise selected by the passengers in their corresponding user profiles. For example, table 320, corresponding to primary passenger, indicates that primary passenger has expressed a preference A in connection with condition 7 and a preference A in connection with condition 8. Similarly, table 322A, corresponding to secondary passenger A, indicates that secondary passenger A has expressed a preference C in connection with condition 7 and a preference A in connection with condition 8. Table 322B, corresponding to secondary passenger B, indicates that secondary passenger B has expressed a preference A in connection with condition 7 and a preference B in connection with condition 8. Finally, table 332C, corresponding to secondary passenger C, indicates that secondary passenger C has expressed a preference A in connection with condition 7 and a preference A in connection with condition 8.

Applying the pre-matching technique, the preference of the primary passenger, which in particular embodiments may be the first passenger picked up by the AV, are used to pre-match one(s) of the secondary passengers A-C who are under consideration for being added to the shared ride. In the illustrated example, the preferences of secondary passenger C (table 322C) are an exact match of those of primary passenger (table 320); therefore, passenger C may be added to the shared ride with the primary passenger presumably with minimal disruption to the primary passenger.

In particular embodiments, primary passenger may indicate a range of acceptable preferences for each of the conditions (e.g., conditions 7 and 8) such that secondary passengers having different preferences for conditions may also be added to the shared ride. For example, primary passenger may have indicated that, while their own preference for condition 7 is A, they are fine riding with passengers whose preferences for condition 7 are A or D. Similarly, primary passenger may have indicated that, while their own preference for condition 8 is A, they are fine riding with passengers whose preferences are A or B for condition 8. In this example, secondary passenger B, whose preference for condition 7 matches the primary passenger's preference for condition 7 and whose preference for condition 8 is acceptable to the primary passenger, may also be added to the ride.

In one embodiment of the pre-matching technique, in cases in which one or more secondary passengers' preferences do not match the primary passenger's preferences for a particular condition (e.g., secondary passenger B's preference for condition 8), the primary passenger's preference for that condition will take precedence. In another embodiment of the pre-matching technique, in cases in which one or more secondary passengers' preferences do not match the primary passenger's preferences for a particular condition (e.g., secondary passenger B's preference for condition 8), the voting or averaging technique may be used to determine the preference for that condition for the ride. In yet another embodiment of the pre-matching technique, in a case in which a secondary, or candidate, passenger's preferences do not match the primary passenger's preferences (and additionally and/or alternatively the candidate passenger's preferences do not match the existing consensus conditions of a shared ride), the candidate passenger may be presented with an “opt-in” feature on the app that allows the candidate passenger to join the shared ride even though they might otherwise not be considered a “match.” This option may be particularly beneficial in cases in which, for example, the candidate passenger is pressed for time and/or a shared ride AV is approaching the location of the candidate passenger.

Still another technique may be referred to as pre-selection and is related to the above-described pre-matching technique. Referring again to FIG. 3C, and applying the pre-selection technique, the primary passenger may be presented anonymous preferences of one or more candidate additional passengers (e.g., secondary passengers A-C) and provided with an opportunity to pre-select one or more of them to include in the shared ride.

Yet another technique may be referred to as gaming. Applying the gaming technique, the shared ride passengers may be presented with one or more challenges prior to and/or during a shared ride, with the preference of the winner of the challenge with respect to a particular condition being applied during the ride. In particular embodiments, a different challenge, or game, may be presented for each of several conditions, such that the preferences of different passengers may be applied for different conditions. Additionally and/or alternatively, challenges may be presented throughout the shared ride in connection with one or more conditions, such that the preference for a single condition may change throughout the ride, depending on the preference of the winner of the most recent challenge. As an example, in some embodiments, challenges may be presented via an in-cabin gaming system of the AV or via the user's mobile devices.

In addition and/or as an alternative to being specified in user profiles of a passenger, the passenger's preferences may be indicated on a per-ride basis using a user interface of a ridesharing application on the user's mobile device. Additionally and/or alternatively, a passenger may provide other information about a particular ride, such as the fact that the passenger is traveling with a pet or a child. In the pre-selection or pre-matching situation, that information may be compared to passenger profile information of another passenger (e.g., an indication that a passenger is allergic to animals), information provided by another passenger in connection with the ride (e.g., the passenger would prefer not to travel with children in the vehicle or prefers not to engage in social interaction), or information known about a passenger (e.g., the passenger was playing a song known to be on a preferred playlist of the other passenger) to determine whether the passengers should share a ride.

With particular regard to heating, ventilation and air conditioning (HVAC) consensus for shared rides, it may be possible to match passengers who have expressed similar temperature preferences (either in their user profile or on a per-ride basis) or dynamically calculate an average temperature based on individual passengers personal profiles (e.g., their preferred temperature and/or tendency toward motion sickness), the length of each passenger's ride (which could be used to weight the passenger's preference, with the preference of a passenger whose ride is longer, in either time or distance, being weighted more heavily than that of a passenger whose ride is shorter, in either time or distance, for example), and their order in a wait queue (which may also be used to weight the passenger's preference, with the preference of a passenger who is higher in the queue being weighted more heavily than that of a passenger who is further down in the queue, for example). HVAC consensus may be implemented using cabin system 138 (FIG. 1). A passenger's preferences may also be weighted based on an assigned priority of the passenger relative to other passengers (which priority may be awarded based on passenger history or other factors or considerations, for example).

In some embodiments, in addition to referring to preferences expressed by passengers, in their user profile or on a per-ride basis, for example, other information may be used to determine a passenger's preference or to gather information to be used in determining a consensus among passengers. For example, CV (e.g., one or more of sensor systems 104, 106, 108 (FIG. 1) of the AV may be used to assess the impact of a passenger's clothing (e.g., a heavy coat or lack of a coat) on their perception of cabin temperature, which assessment may be applied in determining a weighted average temperature preference to be implemented by, for example, a cabin system (e.g., cabin system 138 (FIG. 1)). Alternatively, CV and temperature sensors (e.g., one or more of sensor systems 104, 106, 108 (FIG. 1)) of the AV may be used to determine the external temperature for each passenger, with the weighted average temperature preference being adjusted accordingly. Still further, the temperature may be ramped up or down based on the proximity to the next stop, such that if the passenger with the coldest temperature preference is departing the vehicle at the next stop, the cabin temperature is slowly raised as the AV approaches the next stop so that the cabin reaches optimal temperature for the remaining passengers by the time the AV reaches the stop. Moreover, the amount of time the AV door is open upon egress of a passenger (e.g., using cabin system 138 (FIG. 1)) may be used to increase or decrease the effect of external temperature on the temperature in the cabin when a passenger exits the AV, depending on whether the new consensus temperature is higher or lower than the previous ambient temperature and on whether the external temperature of the AV is higher or lower than the current temperature within the AV cabin.

Moreover, a shared ride may be suggested to a passenger who requests a private ride under certain circumstances. For example, it may be determined that preferences of the passenger match preferences of a majority of passengers already participating in a shared ride. Alternatively, the destination requested by the passenger may be identified as an event address (e.g., a stadium or arena), in which case the passenger may be asked if they are going to the event and if they answer in the affirmative, a suggestion may be made that the passenger requests a shared ride instead of a private ride.

### Example Methods for Consensus Determination for AV Shared Rides

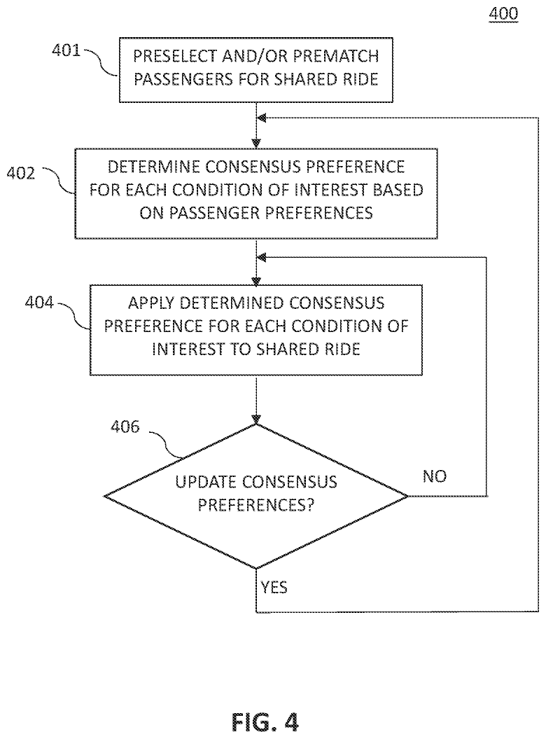

FIG. 4 illustrates a flow diagram 400 of example operations for enabling a method for consensus determination for AV shared rides, according to some aspects of the disclosed technology. In certain embodiments, one or more of the operations illustrated in FIG. 4 may be executed by one or more of the elements shown in FIG. 1.

In optional 401, a pre-selection and/or pre-matching technique may be performed as described above to select two or more passengers from a queue of passengers who have requested shared rides based on common preferences with regard to various conditions of interest among the selected passengers.

In 402, for each condition of interest, a consensus preference is determined. It will be recognized that operation 402 may be performed with reference to preferences of one or more passengers within the AV at the time of the determination using one or more of the techniques described above, such as a majority voting technique, an LCD technique, a gaming technique, and/or an averaging (weighted or unweighted) technique, for example. It will be further recognized that different techniques may be used for determining a consensus preference for different conditions of interest, such that multiple techniques may be used in performing 402.

In 404, the one or more consensus preferences determined in 402 are applied to the AV. For example, an HVAC temperature of the cabin may be set to the consensus temperature, lighting within the cabin may be set to a consensus brightness level, cabin music may be set to a consensus music type, etc. (e.g., via cabin system 138 (FIG. 1)). In other embodiments, a consensus may be reached by combining preferences temporally or otherwise (e.g., by creating a playlist that includes the multiple types of music preferred by the shared ride passengers).

In 406, a determination is made whether a change has occurred that requires a new consensus preference to be determined for one or more of the conditions of interest. Such a change may be, for example, the embarkment or disembarkment of a passenger or determination of a new winner of a challenge. If a negative determination is made in 406, execution returns to 404; otherwise, execution returns to 402 and one or more consensus preferences are updated.

Although the operations of the example method shown in and described with reference to FIG. 4 are illustrated as occurring once each and in a particular order, it will be recognized that the operations may be performed in any suitable order and repeated as desired. Additionally, one or more operations may be performed in parallel. Furthermore, the operations illustrated in FIG. 4 may be combined or may include more or fewer details than described.

### Example Processor-Based System

FIG. 5 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special purpose processor where software instructions are incorporated into the actual processor design. One or more of services 632, 634, and 636 may be involved in implementing one or more operations shown and described in FIG. 4. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a Bluetooth® wireless signal transfer, a Bluetooth® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer,802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more GNSS receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc Read-Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network personal computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Example 1 provides a method of managing a condition of a shared ride provided using an autonomous vehicle (AV), the method including determining individual preferences for the condition expressed by passengers participating in the shared ride; determining a consensus preference for the condition based on the individual preferences; and applying the consensus preference for the condition for at least a portion of the shared ride, wherein the applying the consensus preference for the condition includes managing settings of the AV, including a cabin thereof.

Example 2 provides the method of example 1, wherein the individual preferences are specified in user profiles associated with the passengers participating in the shared ride.

Example 3 provides the method of example 1, wherein the individual preferences are indicated by the passengers on a per-ride basis via user ridesharing application displayed on mobile devices of the passengers.

Example 4 provides the method of example 1, wherein the determining the consensus preference for the condition based on the individual preferences includes selecting one of the individual preferences, wherein the selected one of the individual preference includes an individual preference expressed by a majority of the passengers.

Example 5 provides the method of example 1, wherein the determining the consensus preference for the condition based on the individual preferences includes calculating an average of the individual preferences, wherein the average of the individual preferences includes the consensus preference.

Example 6 provides the method of example 5, wherein the calculating the average further includes applying weights to the individual preferences prior to calculating the average.

Example 7 provides the method of example 6, wherein, for each of the individual preferences, the weight applied thereto is based on at least one of a relative status of the passenger, a queue position of the passenger, and a ride length of the passenger.

Example 8 provides the method of example 1, wherein the determining the consensus preference for the condition includes presenting a challenge to the passengers; determining a winner of the challenge, wherein the winner includes one of the passengers; and assigning the individual preference of the winner of the challenge as the consensus preference.

Example 9 provides the method of example 1, further including, responsive to a triggering condition determining an updated consensus preference for the condition based on the individual preferences; and applying the updated consensus preference for the condition for at least a portion of the shared ride, wherein the applying the updated consensus preference for the condition includes managing the settings of the AV, including the cabin thereof.

Example 10 provides the method of example 9, wherein the triggering condition includes at least one of a new passenger joining the shared ride and one of the passengers leaving the shared ride.

Example 11 provides the method of example 1, wherein the condition includes one of heating ventilation and cooling (HVAC) settings for the cabin, a brightness level of lighting within the cabin, a volume of audio within the cabin, a music genre, and a level of social interaction.

Example 12 provides a method of managing a condition of a shared ride provided using an autonomous vehicle (AV), the method including determining an individual preference for the condition expressed by a primary passenger participating in the shared ride; determining individual preferences for the condition expressed by candidate shared ride passengers; comparing the individual preference expressed by the primary passenger with the individual preferences expressed by the candidate passengers; and selecting based at least in part on the comparing at least one of the candidate passengers to participate in the shared ride with the primary passenger.

Example 13 provides the method of example 12, wherein the individual preferences are specified in user profiles associated with the passengers.

Example 14 provides the method of example 12, wherein the individual preferences are indicated by the passengers on a per-ride basis via user ridesharing application displayed on mobile devices of the passengers.

Example 15 provides the method of example 12, wherein the selecting includes selecting the at least one of the candidate passengers whose individual preference for the condition is identical to the individual preference of the primary passenger.

Example 16 provides the method of example 12, wherein the selecting includes selecting the at least one of the candidate passengers whose individual preference for the condition is acceptable to the primary passenger.

Example 17 provides the method of example 12, further including rejecting a candidate passenger for inclusion in the shared ride based on an unresolvable conflict between the individual preference of the candidate passenger and the individual preference of the primary passenger.

Example 18 provides one or more non-transitory computer-readable storage media including instruction for execution which, when executed by a processor, are operable to perform operations for providing remote assistance to a vehicle, the operations including determining an individual preference for a condition of a shared ride expressed by a primary passenger participating in the shared ride, wherein the shared ride is provided using an autonomous vehicle (AV); determining individual preferences for the condition expressed by candidate shared ride passengers; comparing the individual preference expressed by the primary passenger with the individual preferences expressed by the candidate passengers; and selecting based at least in part on the comparing at least one of the candidate passengers to participate in the shared ride with the primary passenger; determining a consensus preference for the condition based on the individual preference of the primary passenger and the individual preference of the selected at least one of the candidate passengers; and applying the consensus preference for the condition for at least a portion of the shared ride, wherein the applying the consensus preference for the condition includes managing settings of the AV, including a cabin thereof.

Example 19 provides the one or more non-transitory computer-readable storage media of example 18, wherein the individual preferences of the candidate passengers and the individual preference of the primary passenger are specified in user profiles associated with the passengers.

Example 20 provides the one or more non-transitory computer-readable storage media of example 18, wherein the individual preferences of the candidate passengers and the individual preference of the primary passenger are indicated by the passengers on a per-ride basis via user ridesharing application displayed on mobile devices of the passengers.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the interior electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as exterior storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended examples. The specifications apply only to one non-limiting example and, accordingly, they should be construed as such. In the foregoing description, example embodiments have been described with reference to particular arrangements of components. Various modifications and changes may be made to such embodiments without departing from the scope of the appended examples. The description and drawings are, accordingly, to be regarded in an illustrative rather than in a restrictive sense.

Note that with the numerous examples provided herein, interaction may be described in terms of two, three, four, or more components; however, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Various operations may be described as multiple discrete actions or operations in turn in a manner that is most helpful in understanding the example subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended examples. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the examples appended hereto, Applicant wishes to note that the Applicant: (a) does not intend any of the appended examples to invoke paragraph (f) of 35 U.S.C. Section 112 as it exists on the date of the filing hereof unless the words “means for” or “step for” are specifically used in the particular examples; and (b) does not intend, by any statement in the Specification, to limit this disclosure in any way that is not otherwise reflected in the appended examples.

What is claimed is:

1. A method of managing a condition of a shared ride provided using an autonomous vehicle (AV), the method comprising:
determining individual preferences for the condition expressed by passengers participating in the shared ride;
determining a consensus preference for the condition based on the individual preferences; and
applying the consensus preference for the condition for at least a portion of the shared ride, wherein the applying the consensus preference for the condition comprises managing settings of the AV, including settings of a cabin of the AV.

2. The method of claim 1, wherein the determining the consensus preference for the condition based on the individual preferences comprises calculating an average of the individual preferences, wherein the average of the individual preferences comprises the consensus preference.

3. The method of claim 2, wherein the calculating the average further comprises applying weights to the individual preferences prior to calculating the average.

4. The method of claim 3, wherein, for each of the individual preferences, the weight applied thereto is based on at least one of a relative status of the passenger, a queue position of the passenger, a ride length of the passenger, and a health condition of the passenger.

5. The method of claim 1, wherein the individual preferences are specified in user profiles associated with the passengers participating in the shared ride.

6. The method of claim 1, wherein the individual preferences are indicated by the passengers on a per-ride basis via user ridesharing application displayed on mobile devices of the passengers.

7. The method of claim 1, wherein the determining the consensus preference for the condition based on the individual preferences comprises selecting one of the individual preferences, wherein the selected one of the individual preference comprises an individual preference expressed by a majority of the passengers.

8. The method of claim 1, wherein the determining the consensus preference for the condition comprises:
presenting a challenge to the passengers;
determining a winner of the challenge, wherein the winner comprises one of the passengers; and
assigning the individual preference of the winner of the challenge as the consensus preference.

9. The method of claim 1, further comprising, responsive to a triggering condition:
determining an updated consensus preference for the condition based on the individual preferences; and
applying the updated consensus preference for the condition for at least a portion of the shared ride, wherein the applying the updated consensus preference for the condition comprises managing the settings of the AV, including settings of a cabin of the AV.

10. The method of claim 9, wherein the triggering condition comprises at least one of a new passenger joining the shared ride and one of the passengers leaving the shared ride.

11. The method of claim 1, wherein the condition comprises one of heating ventilation and cooling (HVAC) settings for the cabin, a brightness level of lighting within the cabin, a volume of audio within the cabin, a music genre, and a level of social interaction.

12. A method of managing a condition of a shared ride provided using an autonomous vehicle (AV), the method comprising:
determining an individual preference for the condition expressed by a primary passenger participating in the shared ride;
determining individual preferences for the condition expressed by candidate shared ride passengers;
comparing the individual preference expressed by the primary passenger with the individual preferences expressed by the candidate passengers; and
selecting based at least in part on the comparing at least one of the candidate passengers to participate in the shared ride with the primary passenger.

13. The method of claim 12, wherein the individual preferences are specified in user profiles associated with the passengers.

14. The method of claim 12, wherein the individual preferences are indicated by the passengers on a per-ride basis via user ridesharing application displayed on mobile devices of the passengers.

15. The method of claim 12, wherein the selecting comprises selecting the at least one of the candidate passengers whose individual preference for the condition is identical to the individual preference of the primary passenger.

16. The method of claim 12, wherein the selecting comprises selecting the at least one of the candidate passengers whose individual preference for the condition is acceptable to the primary passenger.

17. The method of claim 12, further comprising rejecting a candidate passenger for inclusion in the shared ride based on a conflict between the individual preference of the candidate passenger and the individual preference of the primary passenger, wherein the individual preferences relate to a health condition.

18. One or more non-transitory computer-readable storage media comprising instruction for execution which, when executed by a processor, are operable to perform operations for providing remote assistance to a vehicle, the operations comprising:
determining an individual preference for a condition of a shared ride expressed by a primary passenger participating in the shared ride, wherein the shared ride is provided using an autonomous vehicle (AV);
determining individual preferences for the condition expressed by candidate shared ride passengers;
comparing the individual preference expressed by the primary passenger with the individual preferences expressed by the candidate passengers;
selecting based at least in part on the comparing at least one of the candidate passengers to participate in the shared ride with the primary passenger;
determining a consensus preference for the condition based on the individual preference of the primary passenger and the individual preference of the selected at least one of the candidate passengers; and
applying the consensus preference for the condition for at least a portion of the shared ride, wherein the applying the consensus preference for the condition comprises managing settings of the AV, including settings of a cabin of the AV.

19. The one or more non-transitory computer-readable storage media of claim 18, wherein the individual preferences of the candidate passengers and the individual preference of the primary passenger are specified in user profiles associated with the passengers.

20. The one or more non-transitory computer-readable storage media of claim 18, wherein the individual preferences of the candidate passengers and the individual preference of the primary passenger are indicated by the passengers on a per-ride basis via user ridesharing application displayed on mobile devices of the passengers.
